(19) United States
(12) Patent Application Publication
(10) Pub. No.: US 2003/0038835 A1
(43) Pub. Date: Feb. 27, 2003

(54) Digital camera/e-mail kiosk

(76) Inventor: William D. DeFelice, Guana Bay (NL)

Correspondence Address: SMITH MOORE LLP, P.O. BOX 21927, GREENSBORO, NC, 27420, US

(21) Appl. No.: 10/075,735

(22) Filed: Feb. 14, 2002

Related U.S. Application Data
(60) Provisional application No. 60/314,930, filed on Aug. 24, 2001.

(51) Int. Cl. G09G 5/00

(52) U.S. Cl. 345/738

(57) ABSTRACT

An interactive digital imaging station and method for viewing and e-mailing electronic photos are disclosed. The subject imaging station may comprise a personal computer, a touch screen display, memory card interfaces, a microphone, a credit card reader, a printer, a housing structure, and other components. Customized software and an operating system are preferably provided for use in conjunction with the subject hardware components. Personal electronic images may be transferred from the memory card of a digital camera to the PC of the present subject matter via selected of the provided memory card interfaces. Available memory card interfaces are preferably compatible with presently preferred memory cards, including CompactFlash, SmartMedia, and Memory Stick type memory cards. Stock electronic images may be stored in memory associated with a PC and also be made available to a customer. Ideally, a customer can then view and select certain personal or stock electronic images for sending to a desired recipient via electronic mail. Options may also include printing a copy of a selected digital image. A payment process associated with the subject imaging services is also disclosed.

This application claims the benefit of U.S. Provisional Application No. 60/314,930, filed Aug. 24, 2001.

### BACKGROUND OF THE INVENTION

The present subject matter generally concerns an interactive station that receives and/or creates electronic images and sends selected electronic images to a desired recipient via electronic mail (e-mail). The interactive station preferably receives electronic images from a digital camera or other appropriate accessory and other electronic images are already available as stock photographs.

There may be no better way to capture a moment in time than with a photograph. Since the development of the first film cameras, photography has become an intriguing and near essential form of art. With the advances of modern technology, cameras and other photographic hardware have become much more advanced and accessible to all people. A particular advance in camera technology comes as a result of the new digital age. Digital cameras are now available that can create photographic images using storage of discrete pieces of data that represent a given image. Accessories that complement and advance digital camera technology may thus be commonly desirable. Computers are an example of a specific accessory that enables one to readily access digital photographs. Other accessories enable one to create printed copies of the electronic images captured by a digital camera.

Another advance that has arisen from digital technology is electronic mail (email), a vehicle for transmitting electronic messages among different computer terminals interconnected through a network. Since e-mail transmits electronic messages, it should be appreciated that selected of such messages might include image files or audio clips, both of which can be represented in some digital format. E-mail has thus provided an advanced mechanism for conveniently and quickly sharing an enormity of information, including messages, pictures and other media.

Many people have access to e-mail and other services in their home, but this typically requires a personal computer (PC) and some type of communications connection. It is not uncommon that certain institutions offer this type of technology to those who don't possess or currently have access to such modern devices. It is often the case that a business will provide access to computer and e-mail technology for some predetermined fee. It is known that some institutions offer selected products and/or services for sale or for a fee, respectively, at a kiosk-type structure. Such kiosks are typically available for either vending merchandise such as newspapers or vending services such as film processing. It may thus be desirable for a kiosk structure to provide products and services that encompass a variety of modern digital applications.

U.S. Pat. No. 5,737,729 (Denman) discloses an interactive kiosk for selecting and sending mail pieces. A microprocessor component facilitates selection of the interactive processes available and payment for services is available via a credit card acceptor. U.S. Pat. No. 6,085,191 (Hoyt et al.) also discloses a kiosk-structure, this type being specifically referred to as an “internet photo booth.” This patent discloses a public kiosk and associated computer program for automatically forming a personalized web page.

U.S. Pat. No. 6,161,131 (Garfinkle) discloses an apparatus comprised of a digital camera with a processor and a telecommunication line combination. The processor is asserted as capable of sending a digital image to an e-mail address in a postcard format. Another example of a system for capturing images is provided in U.S. Pat. No. 6,198,544 B1 (Wess et al.) Other examples of systems or methods that deal with imaging applications can be found in U.S. Pat. Nos. 6,018,774 (Mayle et al.), 6,021,417 (Massarsky), and 6,092,104 (Kelly). U.S. Pat. No. 6,032,130 (Alloul et al.) discloses an example of an electronic purchasing system.

The disclosures of all the foregoing United States patents are hereby fully incorporated into this application by reference thereto.

### BRIEF SUMMARY OF THE INVENTION

The present subject matter recognizes and addresses various shortcomings of aspects of digital imaging technology. Thus, broadly speaking, a principal object of the presently disclosed technology is improved digital imaging systems and methods. More particularly, the disclosed interactive electronic image station offers the capability to interface digital camera components and a processor, download selected digital images, and e-mail selected of such images to a desired recipient.

Another principal object of the present subject matter is to provide various hardware components for use in conjunction with the aforementioned digital imaging system and method. Such hardware components preferably include at least a PC or equivalent processing device, a touch screen display, digital camera interface and payment processing capabilities.

Yet another principal object of the present invention is to provide software for facilitating the subject interactive station, such software effecting the ability to view electronic images and send to a recipient.

It is a fundamental object of the subject interactive station to provide the ability to interact with personal images or stock images in accordance with the presently disclosed technology.

It is yet another fundamental object to provide a means for interfacing with a digital camera in order to introduce personal images to the subject interactive station.

It is a further object of the present invention to provide a kiosk environment to house the interactive system of the present invention, including both hardware and software based components.

Additional objects and advantages of the invention are set forth in, or will be apparent to those of ordinary skill in the art from, the detailed description herein. Also, it should be further appreciated by those of ordinary skill in the art that modifications and variations to the specifically illustrated, referenced, and discussed features and steps hereof may be practiced in various embodiments and uses of this invention without departing from the spirit and scope thereof, by virtue of present reference thereto. Such variations may include, but are not limited to, substitution of equivalent means and features, materials, or steps for those shown, referenced, or discussed, and the functional, operational, or positional reversal of various parts, features, steps, or the like.

Still further, it is to be understood that different embodiments, as well as different presently preferred embodiments, of this invention may include various combinations or configurations of presently disclosed features, steps, or elements, or their equivalents (including combinations of features or steps or configurations thereof not expressly shown in the figures or stated in the detailed description). A first exemplary embodiment of the present subject matter relates to an interactive digital imaging station for viewing and sending digital images. The interactive station preferably comprises a standard PC, a memory card interface, a touch screen display, and a communications connection. The memory card interface may be compatible with a selected type of digital camera memory card such as CompactFlash, SmartMedia, and/or Memory Stick. The interface can preferably be modified accordingly if improved or preferred memory card advances occur. The PC is preferably characterized by various ports for connection to selected peripheral devices. Such ports might include a serial port, a parallel port, a modem connection, a universal serial bus (USB) port, and a Personal Computer Memory Card International Association (PCMCIA) connection. The communications connection should ideally at least be capable of offering a dial-up connection to the internet or other information network.

An additional exemplary embodiment of the present subject matter corresponds to a digital imaging kiosk comprising a housing structure, a PC, a screen display, at least one memory card interface, a microphone, a video camera, a credit card reader and a receipt printer. The housing structure preferably provides a secure and stable operating environment for all hardware and computing components of the subject application. The screen display is preferably touch-sensitive and thus capable of determining input from the user. It may be preferred to include more than one memory card interface such that different memory card interfaces are compatible with different memory card types, thus offering extended versatility of the imaging system. The microphone is preferably interfaced with the PC such that a user can input a personalized audio clip for sending in combination with selected digital images. The video camera is preferably interfaced with the PC such that a user can input a personalized video clip for sending in combination with selected digital images. The subject credit card reader preferably includes at least a magnetic strip reader to determine a customer's credit card information, and the receipt printer can provide convenient output related to a particular payment process.

Additional exemplary embodiments of the subject interactive digital imaging station may comprise selected elements of the aforementioned embodiments in combination with additional components. Such additional components may include a ventilation fan and access door for incorporation with a housing structure. A keyboard, mouse, or other device may be used instead of or supplemental to the touch screen display for providing user input to the PC. Power strips and cables are preferably used to interface selected hardware components to an appropriate power source. Printer components may also be included that provide the capability to not only print receipts, but also to print copies of selected electronic images.

Selected exemplary embodiments of the present subject matter should preferably be characterized by an ability to view selected personal images captured with a digital camera or to view stock images stored in memory associated with selected hardware components of the subject interactive station. The station should also preferably have the ability to e-mail either selected personal or stock images to an e-mail address for a specified recipient.

Additional embodiments of the subject invention, not necessarily expressed in this summarized section, may include and incorporate various combinations of aspects of features or parts referenced in the summarized objectives above, and/or features or parts as otherwise discussed in this application.

Those of ordinary skill in the art will better appreciate the features and aspects of such embodiments, and others, upon review of the remainder of the specification.

### BRIEF DESCRIPTION OF THE PREFERRED EMBODIMENTS

A full and enabling description of the present invention, including the best mode thereof, directed to one of ordinary skill in the art, is set forth in the specification, which makes reference to the appended figures, in which:

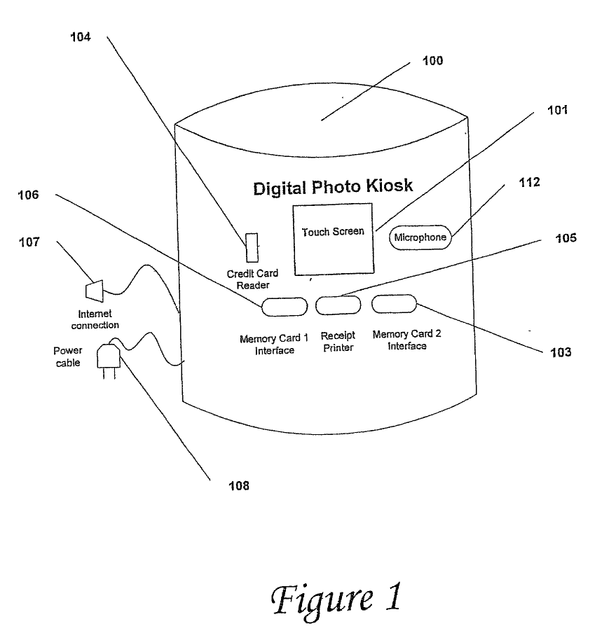

FIG. 1 illustrates a generally front view of an exemplary digital photo kiosk in accordance with the present subject matter;

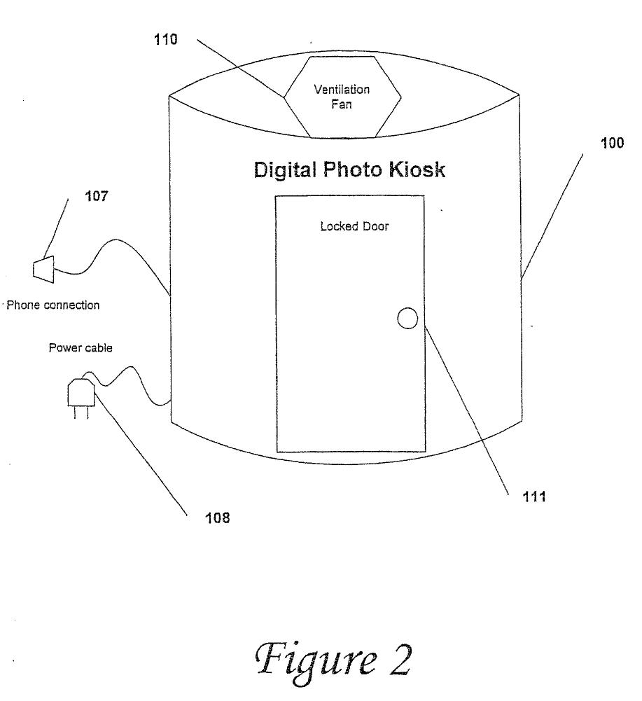

FIG. 2 illustrates a generally rear view of an exemplary digital photo kiosk in accordance with the present subject matter;

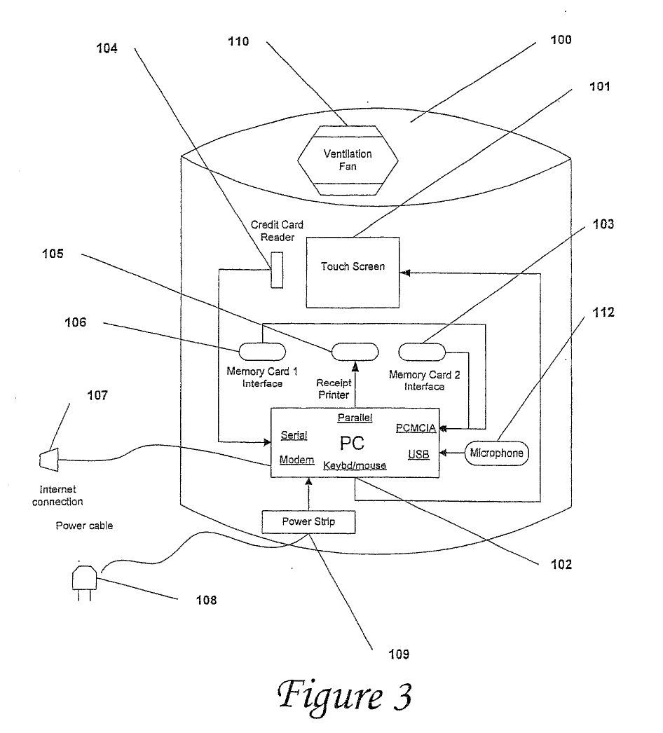

FIG. 3 provides a block diagram of exemplary internal components for use in an exemplary digital photo kiosk in accordance with the present subject matter;

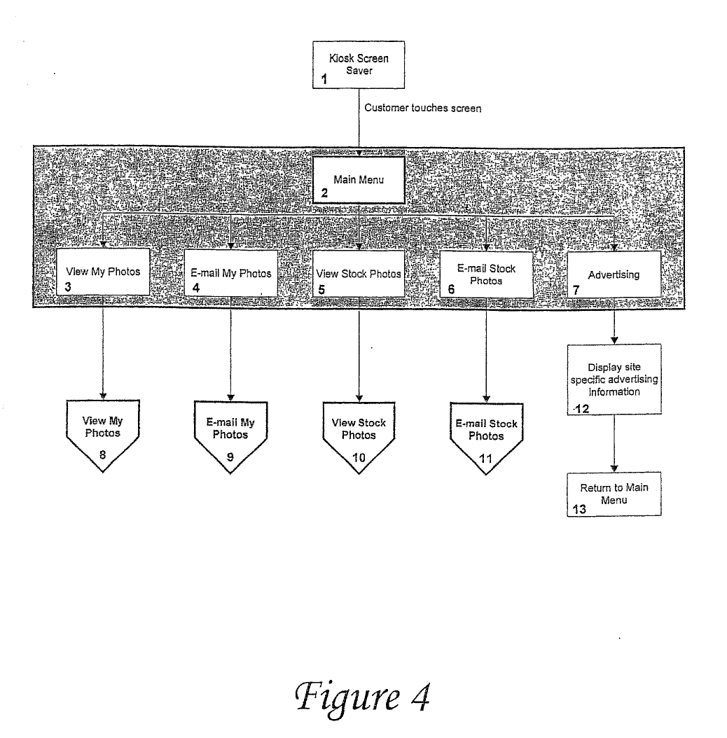

FIG. 4 displays exemplary interactive features for use in accordance with digital imaging technology of the present subject matter;

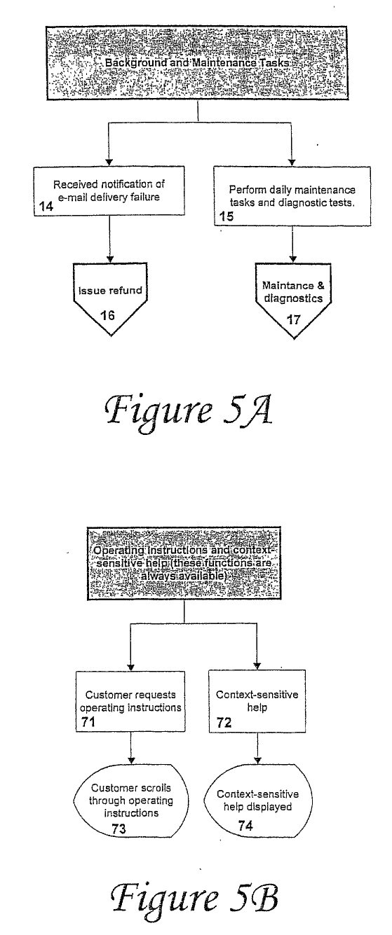

FIGS. 5A and 5B display additional exemplary interactive features for use in accordance with the digital imaging technology of the present subject matter; and

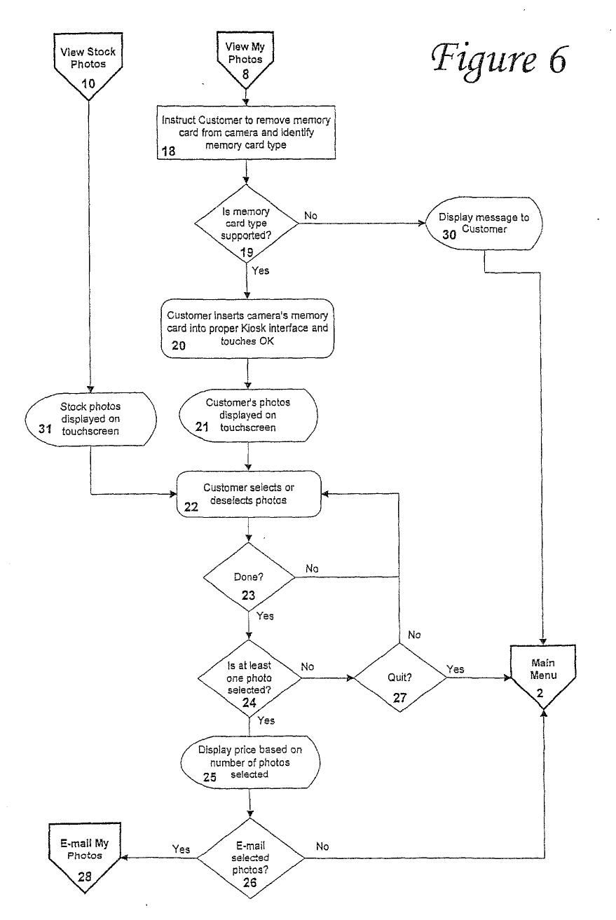

FIGS. 6 through 9 respectively display flow chart representations of exemplary procedures corresponding to selected interactive features in accordance with the present digital imaging technology.

Repeat use of reference characters throughout the present specification and appended drawings is intended to represent same or analogous features or elements of the invention.

### DETAILED DESCRIPTION OF THE DRAWINGS

As referenced in the Brief Summary of the Invention section, supra, the present subject matter is directed towards an interactive station that receives and/or creates electronic images and sends selected electronic images to a desired recipient via electronic mail (e-mail). The interactive station preferably receives electronic images from a digital camera or other appropriate accessory and/or other electronic images are already available as stock photographs.

Hardware components for such an interactive station may preferably include a personal computer (PC) or similar appliance for processing digital images and other information, a touch screen display for providing input to the personal computer, a magnetic strip reader to facilitate payment capabilities, a printer for providing output to a user, an internet connection for expanding the information available to the interactive station, and a memory card interface for effecting a process to download digital images. Each exemplary hardware component listed above may be replaced or used in conjunction with different hardware components that perform the same or similar function as the above component(s). Additional hardware may preferably be used in addition to the aforementioned components, and examples of such additional hardware will be disclosed later in the specification. Multiple views of exemplary hardware components and a kiosk structure for effecting an interactive digital imaging station in accordance with the subject technology are illustrated in FIGS. 1, 2 and 3.

The operation of the hardware components is preferably controlled by an operating system and software that resides in the PC. Main interactive features that are preferably implemented via software are selectable from a main menu. Main menu features may ideally include choices such as viewing personal photos, e-mailing personal photos, viewing stock photos, e-mailing stock photos, and providing related product and service information. An exemplary flow chart representation of interactive features available from a main menu is displayed in FIG. 4. Additional features may be available from supplemental menus, such as those displayed in FIGS. 5A and 5B, and may include performing background and maintenance tasks associated with an interactive station or providing operating instructions and context-sensitive help. Additional processes that may be effected through interfaced elements of the subject invention may include providing and connecting a memory card, selecting various electronic images, providing pertinent e-mail information, and utilizing a credit card payment process. Exemplary flow chart representations of selected of such interactive processes are presented in FIGS. 6, 7, 8 and 9. One of ordinary skill in the art would know how to implement the flow chart information herewith in the exemplary hardware referenced or in equivalent devices. The exemplary components and processes of the present digital imaging technology will be discussed in further detail in the remainder of the specification.

Now referring to the drawings, FIG. 1 illustrates a generally front view of an exemplary digital photo kiosk 100 in accordance with other exemplary hardware and software components of the present invention for creating an interactive digital imaging station. The digital photo kiosk 100 preferably comprises a housing constructed of a durable material that will be able to withstand extended use and a variety of environmental conditions, such as heat, moisture, and other extreme conditions. The housing 100 itself may incorporate additional decorative features for improving the aesthetic appearance of the interactive station. Such decorative features in combination with optional functional characteristics of an exemplary kiosk structure 100 may be specifically selected for an individual location of an interactive station. It will be understood that the digital imaging technology disclosed herein may be utilized without housing the hardware and software components in such aforementioned kiosk structure 100.

The kiosk structure 100 can ideally be installed at numerous locations without extensive modification or cost at varying locations. However, two essential resources are required for proper operation of selected components of the present subject matter. A first resource is electrical power, which may preferably be provided by connecting power cable 108 from a suitable power source to the hardware components of the interactive station that require electrical energy. The PC component of the present invention processes a variety of digital information that can be provided by the user or taken from stored data. Another method for obtaining digital information for use in accordance with the subject digital imaging technology is to retrieve such information from the Internet or other electronic communications network. For facilitating this exemplary process, an internet connection 107 must be provided to the appropriate hardware. An example of how internet connection 107 may be implemented is by connecting the appropriate port from PC 102 to a standard RJ-11 phone jack for a dial-up connection. Other communications media may alternatively be utilized for effecting a high speed connection to the internet or other information network.

Other hardware components that may preferably be visible to a user, as displayed in FIG. 1, include a credit card reader 104, touch screen 101, microphone 112, video camera, memory card interfaces 103 and 106, and receipt printer 105. A large touch screen display 101 may be either a cathode ray tube (CRT) screen or a flat panel display (FPD) screen, and preferably (just for ease of use) is at least a 17″ display. Touch screen 101 may be used for entering information such as e-mail addresses or other information required from the user. A touch screen keyboard display can be used for the data entry. Although an interactive station with minimized component number may incorporate only touch screen input, a mouse or separate keyboard may also be used for input to PC 102. Microphone 112 is also provided as an additional device for inputting information to PC 102. Appropriate software can be employed for converting the audio input to microphone 112 into digital information. A video camera may be provided as a device for inputting information into the PC 102. Appropriate software can be employed for converting the video input to the video camera into digital information.

One purpose of the subject digital imaging station is to be able to receive electronic images taken by a digital camera. Transferring the appropriate information from a digital camera to the digital imaging station is preferably done by interfacing the memory card of a digital camera to a connector incorporated into the digital imaging station. A select few varying types of memory cards currently exist, including CompactFlash, SmartMedia, and Memory Stick type memory cards. An interface to the memory card of a digital camera may be ideal since additional camera cables will not be needed for such a connection. At least one, but preferably more memory card interfaces are provided in the interactive imaging station of the present invention. The exemplary digital photo kiosk 100 of FIGS. 1 through 3 provides a first exemplary memory card interface 103 corresponding to a first type of memory card and a second exemplary memory card interface 106 corresponding to a second type of memory card.

An alternative method for transmitting images from a digital camera to an interactive imaging station is to directly connect the camera to the appropriate hardware components. This method may require that a customer provide the appropriate cable for connecting a specific digital camera to the station. No standard cable or connector is currently available to interface all digital camera types, and thus many connector types would be made available in the interactive station. Additional software would also be utilized in this case to copy images from each different manufacturer's camera. If a standard connection is made available, then the components of the present invention could readily be modified to incorporate such new interfacing and software features.

Exemplary hardware components for an interactive station of the subject invention that deal with payment options include credit card reader 104 and receipt printer 105. Credit card reader 104 preferably comprises a magnetic strip reader for swiping credit cards. The cost for services provided at a digital photo kiosk 100 can then be billed to a specified credit card account. Phone jack connection 107 can also be used for dial-up verification of an user's credit card account information. Upon verification of the appropriate payment information, a receipt may be provided to the user via receipt printer 105. Alternative payment methods may also be incorporated into digital photo kiosk 100, and might include a cash input location and appropriate software.

It may also be desirable not only to e-mail selected electronic images, but also to print copies of selected electronic images. If such a feature is to be incorporated into the interactive imaging station, receipt printer 105 may comprise a printer capable of printing photos as well as receipts. Different paper type may be provided in such a case for printing the different outputs. In other embodiments of the invention, separate printers may be available such that one printer outputs electronic image prints and another printer 105 outputs payment receipt information.

Referring more particularly to FIG. 1, digital photo kiosk 100 may be configured for use by a single customer, who preferably stands in front of the kiosk 100. Alternative embodiments of kiosk 100 may provide a seating location for the user or may provide sufficient room such that kiosk 100 may be used by more than one user. When the kiosk 100 and digital imaging station therein is not in use, a screen saver appears continuously on screen 101. The screen saver may preferably be an attract message that is intended to gain customers for the kiosk 100. Supplemental messages would preferably be provided to invite a customer to press touch screen 101 to obtain further information about the services provided by kiosk 100. As a customer touches screen 101, a screen saver (if present) disappears and a main menu appears on the screen 101. A main menu may offer the exemplary features displayed in FIG. 4.

FIG. 2 illustrates a generally rear view of an exemplary digital photo kiosk such as that displayed in FIG. 1. Kiosk structure 100 preferably has a rear door 111 for internal access to the kiosk 100. The door 111 would preferably remain locked to provide secure access to and protection for the hardware components of the subject technology. A ventilation fan 110 is also preferably provided with kiosk structure 100 to ensure preferred operating conditions for the internal components.

FIG. 3 provides a generally interior view of exemplary internal components for use in a digital photo kiosk in accordance with the present subject matter. FIG. 3 is intended to depict the components seen from the exterior front side of kiosk 100, such as those seen in FIG. 1, selected components seen from the exterior rear view of kiosk 100, such as seen in FIG. 2, in addition to components accessible only from the interior of the structure 100. A power strip 109 is provided to connect the power cords of each appropriate hardware component of the present subject matter. The power strip preferably has surge protection so that all hardware components are safeguarded during an occurrence of transient input voltage overload to the power strip 109.

A more detailed representation of the PC 102 is also provided in FIG. 3. As is known in the art of computing hardware, many different types of systems may be available and utilized in accordance with this and other technologies. It is appreciated that many different PC configurations could offer the necessary functionality for the subject application. However, minimum system requirements may preferably include at least 64 megabytes (MB) of random access memory (RAM), a hard disk containing at least about 20 gigabytes (GB) of memory, an Intel Pentium III brand processor or other processor with equivalent processing capabilities and a clock speed of at least 300 megahertz, a dial-up modem at a minimum of 56 kilobaud, a serial port, a parallel port, and associated cables. Again, the specific details of the PC configuration 102 may vary and may be readily changed over the life of the digital kiosk 100, as well understood by those of ordinary skill in the art.

Connections among various hardware components of the interactive station are also represented in FIG. 3. Credit card reader 104 is preferably connected to the serial input port of PC 102. Internet connection 107 is preferably routed to the modem port of PC 102. Receipt printer 105 is preferably connected to the parallel input port of PC 102. As previously discussed, external memory card interfaces 103 and 106 are provided to connect to memory cards of a digital camera. These external interfaces then preferably connect to Personal Computer Memory Card International Association (PCMCIA) connectors located on PC 102. Finally, microphone 112 and a video camera are preferably connected to USB ports provided with PC 102.

Reference will now be made to the software portions of the subject digital imaging technology. The operation of the interactive digital imaging station is controlled by the software that is incorporated with PC 102. The software preferably includes custom software for directing tasks specific to the subject digital photo technology in conjunction with a standard operating system such as Microsoft Windows 2000 or other system. The digital imaging station is inactive if touch screen 101 displays a predetermined screen saver.

Referring to FIG. 4, when a user then touches screen 101, the screen saver disappears and a main menu 2 is displayed. Main menu 2 contains choices of interactive features that the customer can select by touching the screen, preferably to the left of each choice. If the customer does not make a choice from the main menu 2 within a predetermined time period, for example five minutes, then the screen saver reappears on touch screen 101. Choices for the interactive features include viewing personal photos 3, e-mailing personal photos 4, viewing stock photos 5, e-mailing stock photos 6, and advertising 7. Selection of a specific interactive feature then brings a customer to a respective process of viewing personal photos 8, e-mailing personal photos 9, viewing stock photos 10, or e-mailing stock photos 10. A customer would ideally select the “View My Photos” 3 or other appropriately named choice if he/she would like to view photos currently stored on the memory card of a personal digital camera. The user would pick the “E-mail My Photos” 4 or other appropriately named choice if the user would like to e-mail one or more of their pictures to a desired recipient. A “View Stock Photos” 5 or alternatively termed similar option would be chosen to look at the stock pictures that are available to the interactive station. To e-mail selected stock photos, an “E-mail Stock Photos” 6 choice is effected. Selection of an additional advertising feature 7 will provide a user with display site 12 that advertises products and services that may be offered by the kiosk or the location where the kiosk is located. After displaying information in step 12, the user is directed to step 13 and preferably returned to the main menu.

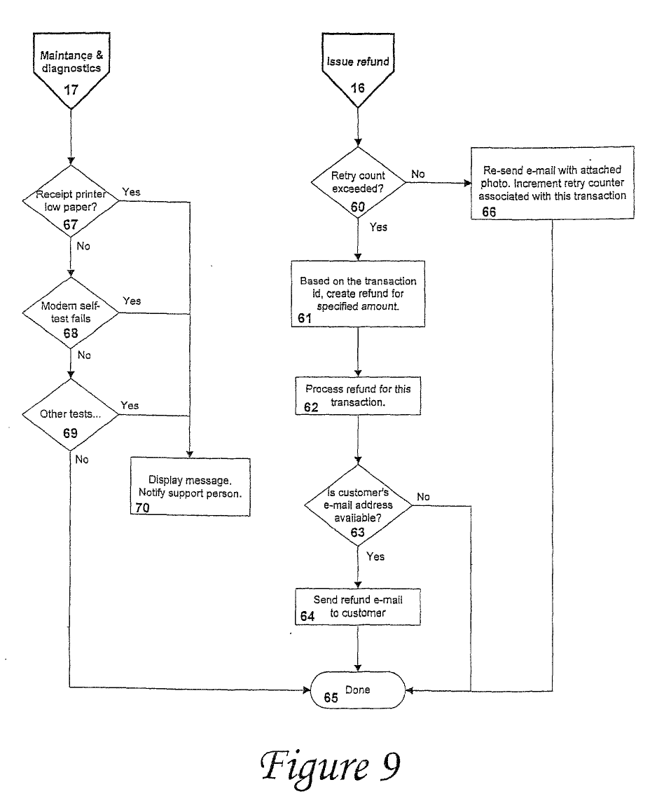

Additional software features not displayed in the main menu 2 of FIG. 4 are illustrated in FIGS. 5A and 5B. FIG. 5A illustrates a supplemental menu of software options that correspond to background and maintenance tasks. Certain steps of the subject technology include e-mailing electronic images to a recipient and paying for that service via credit card. If a notification is received 14 signifying that there was a failure in delivering the e-mail, then a refund is issued (step 16). This process is discussed with reference to exemplary software logic in FIG. 9. If a e-mail is not properly sent, then the e-mail with attached photo is re-sent and a retry counter associated with that particular transaction is incremented. The photo is repeatedly re-sent until it the message is properly sent or until the retry counter exceeds a predetermined threshold at step 60. If the retry count threshold 60 is exceeded, then an appropriate transaction ID is referenced and a refund for the specified amount is created (step 61). The refund is then processed for that transaction in step 62 by crediting the amount back to the credit card used for the original transaction. If the customer's e-mail address is made available (step 63) during the photo process, then an e-mail is sent to that address in step 64 alerting the customer of the refund. If the customer's e-mail address is not available, then the refund process is done (step 65). Alternatively, the subject interactive system may wait for verification of proper e-mail delivery before charging the credit card account in the first place.

Certain daily maintenance may be beneficial for proper operation of software and hardware components. An option is preferably provided in step 15 (FIG. 5A) in a supplemental maintenance task menu to perform daily maintenance tasks and diagnostic tests (step 17). Such tests may scan the system for viruses, update system information, and ensure proper connection and functionality of various hardware components. It may be desirable for the maintenance and diagnostics task 17 to be periodically performed in some automatic fashion without selection from a supplemental menu. This option can be specified accordingly with appropriate software modification.

Specific maintenance and diagnostic functions are discussed with reference to FIG. 9. Minimal self-diagnostics include a check to determine if receipt printer paper is low (step 67) and to see is a modem self-test works (step 68). Other tests may be implemented (step 69), and if any diagnostic test fails then a message is displayed (step 70) to notify the proper support person.

Further additional exemplary software features are included in menu representation of FIG. 5B and relate to operating instructions for the digital kiosk 100. A touch-activated button, preferably referring to kiosk operating instructions may be displayed throughout most of a typical customer transaction. Selection of this button in step 71 would cause general instructions for using the interactive system to be displayed in step 73. In addition, a context-sensitive help option (step 72) will preferably be available during several portions of a typical transaction. Selection of this option 72 causes instructions specific to the operation currently under way to be displayed in step 74.

FIG. 6 displays a flow chart representation of exemplary procedures corresponding to viewing personal photos feature 8 and a viewing stock photos feature 10 in accordance with the disclosed technology. When a customer selects the viewing personal photos option 8, they are prompted to identify the type of memory card type in their digital camera (step 18). This step 18 may be effected by removing the memory card from the camera and matching it to different images of supported memory card types that are presented on touch screen 101.

In the exemplary kiosk embodiment of FIGS. 1 through 3, only two memory card interfaces 103 and 106 are provided. For this particular embodiment then, three different choices are available to the customer for matching the memory card type: Type 1, Type 2, or Not Supported. If the memory card type matches Type 1, then the customer is instructed to touch “Type 1” and similarly, if the card type matches Type 2, they are instructed to touch “Type 2.” If the customer's memory card does not match either Type 1 or Type 2, then the customer is directed to touch the “Not Supported” button. If a customer's memory card is not supported, then a preconfigured message appears on the display 101 in step 30 and the software then returns to the main menu 2. It should be appreciated that similar software could be provided to account for only one type of memory card interface or more than two types of memory card interfaces for use in conjunction with the interactive operating station.

Once a customer's memory card is identified, the customer is instructed to insert the memory card into the proper interface 103 or 106. These interfaces 103 and 106 are mounted on the front of kiosk structure 100 such that they are readily accessible by customers and appropriately labeled for convenience. Once a memory card is inserted to the appropriate interface 103 or 106, then the customer is prompted to touch OK (step 20).

Once the customer's memory card is inserted into the proper interface connector 103 or 106 and an “OK” button is touched at step 20, the software retrieves the photos from the memory card and displays them on the touch screen. The next step is a selection process 21 that shifts a movable electronic frame among the available pictures for identification purposes. Initially, the frame appears around the first electronic image as a border around the image. Four arrow keys are preferably provided for moving the frame in any direction among the photographs. A SELECT button (step 22) is available to indicate that the customer wishes to select the photo that currently has the frame. An indication of the frame to be selected is also preferably provided. To deselect a selected image, the customer is instructed to position the frame on the desired photo to deselect and then touch the DESELECT button (also at step 22). Once the customer is finished selecting and/or deselecting photos, the customer is instructed to press a DONE button at step 23. Upon touching the DONE button at step 23, the software checks to see if at least one photo is selected. If no photos are selected at step 24 then the customer has the option of quitting (step 27) and returning to main menu 2. If at least one photo is selected at step 24 then the software computes the price based on the number of photos selected. The price is displayed at step 25 and the customer is asked to confirm if this is OK. In the case where the user's memory card is full, the user may select all of the photos to be e-mailed to the user's own e-mail address, for example, so that the user may delete those photos from the memory card and free memory for new photos. In one embodiment of the present invention, the digital image station provides a menu option that allows the user to instruct the image station automatically delete various ones or all of the photos stored on the memory card.

A similar photo selection process corresponds to the process for viewing stock photos 10. Once option 10 is selected, a plurality of stock photos are displayed in step 31 on touch screen 101. The customer may then select or deselect photos similar to the SELECT/DESELECT process 22 described above. At any point during the process of viewing and selecting photos, the customer can also select QUIT (step 27) and be returned to the main menu 2. A HELP option 72 is also available so that customers can view specific instructions related to selecting photos.

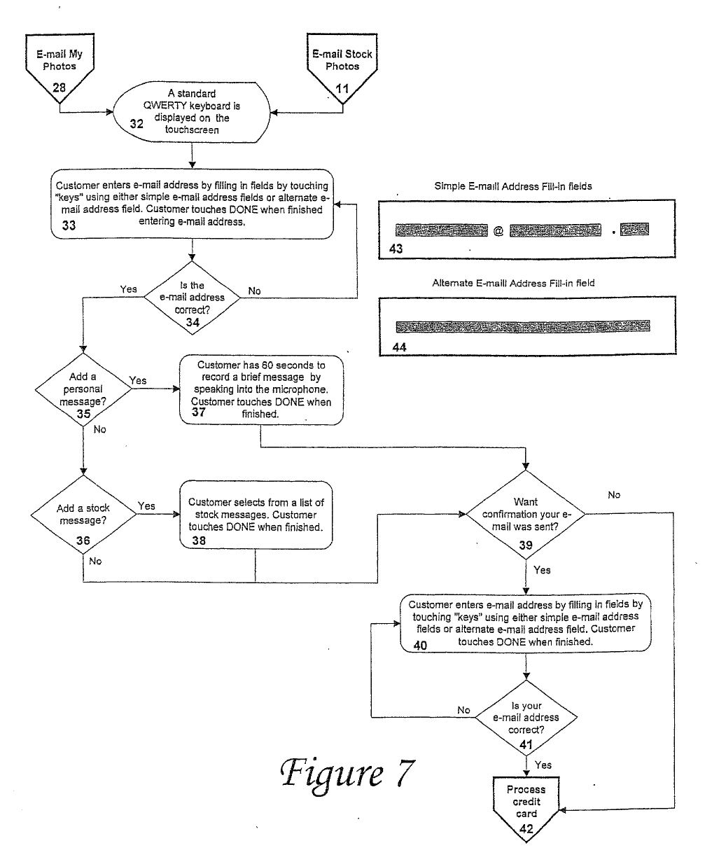

The end of a photo selection process naturally proceeds to a photo e-mail process. Selection of either the e-mailing personal photo option 28 or the e-mailing stock photo option 11 also proceeds to the e-mail process displayed in FIG. 7. The customer may be asked if they wish to e-mail the selected photo(s). If they choose not to, then the customer will be returned to the main menu 2. If the customer chooses to, then a standard QWERTY keyboard is displayed at step 32 on touch screen 101. This interactive feature is then used in step 33 to enter the desired recipient's e-mail address. In addition, an example of a simple e-mail address is displayed in step 43 and a cursor appears in the leftmost field of the form. The customer is instructed to type the e-mail address by touching the keys on the keyboard displayed on the touch screen 101. Available keys preferably include NEXT FIELD, PREVIOUS FIELD, and DONE. For simple e-mail addresses (step 43), the customer is not required to type the @ (at) and the . (dot) symbols. If the e-mail address of the intended recipient does not match the simple example per step 43, then the customer may have to type the @ (at) key and the. (dot) key as well as any other symbols that are part of the alternate e-mail address per step 44. The NEXT FIELD and PREVIOUS FIELD buttons are not displayed for the alternate email field per step 44. Left and right arrow keys will also be included in the list of keys to display for both types of e-mail addresses.

In the course of the e-mail entering process 33, when a customer has completed the entry in the leftmost field of a simple e-mail address per step 43, the customer is prompted to press the NEXT FIELD button, which moves the cursor to the next field. When the customer has finished entering the e-mail address, they are instructed to select a DONE option. After touching DONE, the customer is asked to check the e-mail address and verify that it is correct (step 34).

After ensuring that a given e-mail address is correct, the option is provided to a customer to include a brief personal message (step 35). If the customer chooses to do this, microphone 112 is turned on and the customer is instructed to speak clearly into the microphone 112. The customer has 60 seconds to record their message. When finished, the customer presses a DONE button. As an alternative to entering a personal message, the customer is offered the option to include a stock message (step 36) with the e-mail. The customer can then select from a list of stock messages (step 38) and presses DONE when finished. Alternative embodiments may incorporate video messages instead of audio messages. If the customer chooses to do this, a video camera in the kiosk is turned on and the customer is instructed to look into the video camera and speak its message. When finished, the customer presses a DONE button. A further alternative embodiment may incorporate written text messages. Such messages may be input by a keyboard display on touch screen 101. Voice recognition software could then be used to convert between the written text messages and audio when appropriate.

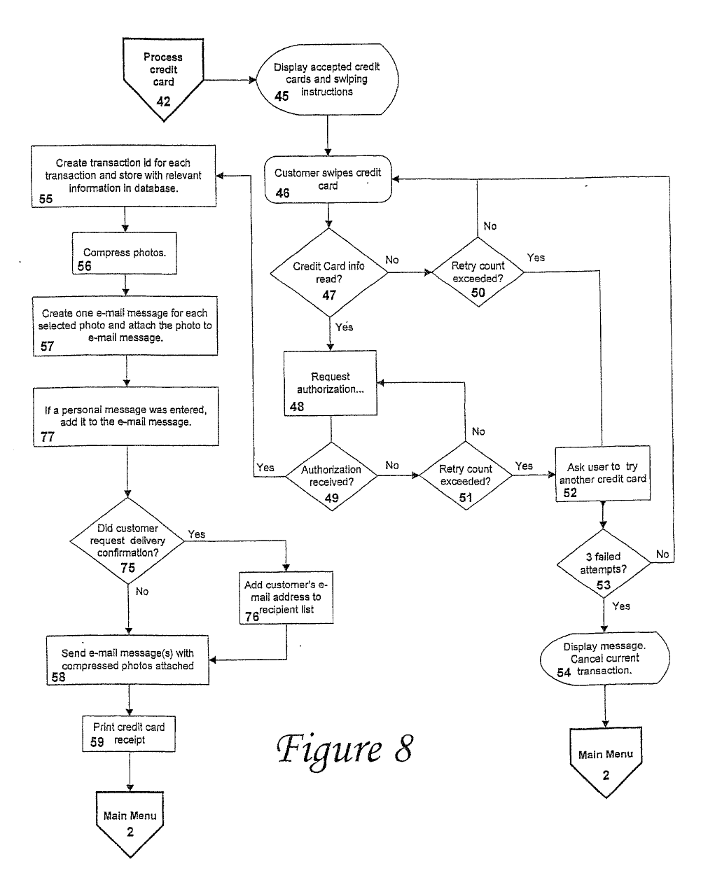

Each customer is then given the option in step 39 of whether they want to receive an e-mail message at their e-mail address that confirms that the customer's photo(s) were in fact sent to the intended recipient. If the customer wishes to do this, then they are instructed to enter their e-mail address in a process similar to that for the intended recipient (per steps 39, 40 and 41). A simple e-mail address field and an alternate address e-mail field are similarly provided for the process 40 of entering the e-mail address. After all steps are completed regarding e-mailing of the selected photos, a customer is routed to the payment process 42, as displayed in FIG. 8.

After the recipient's e-mail address has been entered and verified, the customer is informed at step 45 of which credit cards are accepted by the interactive station and how to correctly swipe their credit card using the credit card reader 104 located on the kiosk 100. The customer swipes the credit card per step 46. If the credit card is not read properly, then the customer is instructed to swipe it again per step 47. After three failed attempts (step 50) to read a credit card, the customer is preferably instructed to try another credit card per step 52. After trying up to three different credit cards per step 53, a message is displayed and the current transaction is canceled per step 54. At such point, the touch screen 101 returns the display to the main menu 2.

If the credit card is read successfully, then an authorization request per step 48 to charge the credit card the amount approved by the customer is sent to an online credit card processing company. The message is preferably sent in an encrypted format using 128-bit Secure Socket Layer (SLL) compatible web browser. Schemes using digitally encrypted certificates may be used to provide secure, authenticated communications that protect the customer's credit card number.

Once the credit card authorization is received in step 49, a transaction record is created for each transaction and stored per step 55 with relevant information in a database on the PC 102. The selected photos are then compressed by converting them to a format such as a .jpeg or PDF. By compressing the photos, the files that contain them will be much smaller. This is an issue since some e-mail applications do not accept messages that contain attached files that are larger than 1 MB. An alternative to compressing the images is to use a server for the repository for images. A small e-mail message containing a link to the image on the server would then be sent. In this way, there would be no problem of non-delivery due to excessive file size.

A separate e-mail message is then created per step 57 for each photo selected by the customer. The individual files that contain the photos are then attached to an e-mail message along with the customer's personal message, if one was created (step 77). If the customer requested a confirming message, their e-mail is added to the recipient list per step 76. The e-mail messages are then sent using an SSL-compatible browser (step 58). Lastly, the credit card receipt is printed per step 59 using the printer 104 in kiosk 100 and the customer is reminded to take their receipt. At the end of this transaction, the touch screen 101 returns to the main menu display 2.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An interactive electronic image station for viewing and sending electronic images comprising:
a computer having an Internet connection;
at least one interface connected to said computer for uploading an electronic image from a storage medium to said computer; and
a display screen connected to said computer;
wherein a user stores said electronic image on a storage medium with an electronic storage device and transfers said electronic image from said storage medium to said computer via said interface; and
wherein said user views said electronic image on said display screen and electronically sends said electronic image to a desired recipient over the Internet.

2. The interactive electronic image station of claim 1 wherein said computer comprises memory that stores pre-selected electronic images and said user views at least one of said pre-selected images on said display screen and electronically sends said at least one of said pre-selected images to said desired recipient over the Internet.

3. The interactive electronic image station of claim 1 wherein said interactive electronic image station is housed in a kiosk environment.

4. The interactive electronic image station of claim 1 further comprising a microphone and an audible storage medium connected to said computer that enables said user to record an audible message and electronically send said audible message with said electronic image to said desired recipient over the Internet.

5. The interactive electronic image station of claim 1 wherein said computer comprises memory that stores pre-selected audio clips and said user listens to at least one of said audio clips and electronically sends said at least one of said pre-selected audio clips to said desired recipient over the Internet.

6. The interactive electronic image station of claim 1 further comprising a video camera and a video storage medium connected to said computer that enables said user to record a video clip and electronically send said video clip with said electronic image to said desired recipient over the Internet.

7. The interactive electronic image station of claim 1 further comprising a magnetic strip reader for reading a card having a magnetic strip to render payment for use of said interactive electronic image station.

8. The interactive electronic image station of claim 1 further comprising a printer for generating a receipt for payment for use of said interactive electronic image station.

9. The interactive electronic image station of claim 1 further comprising a printer for printing said electronic image.

10. The interactive electronic image station of claim 1 wherein said display screen is touch sensitive and said interactive electronic image station is operated by said user touching said display screen.

11. The interactive electronic image station of claim 10 wherein said display screen includes a touch screen keyboard that allows said user to input data.

12. The interactive electronic image station of claim 11 wherein said data input by said user is an e-mail address for said desired recipient.

13. The interactive electronic image station of claim 1 wherein said user inputs a personal text message and electronically sends said personal text message with said electronic image to said desired recipient over the Internet.

14. The interactive electronic image station of claim 1 wherein said storage medium is a memory card selected from the group consisting of Compact Flash, SmartMedia and Memory Stick.

15. The interactive electronic image station of claim 1 wherein said at least one interface is a port selected from the group consisting of a serial port, parallel port, universal serial bus port, and personal memory card international association connector.

16. The interactive electronic image station of claim 1 wherein said at least one interface comprises at least one cable.

17. The interactive electronic image station of claim 1 wherein said computer deletes said electronic image from said storage medium upon instruction from said user.

18. An interactive electronic image station for viewing and sending electronic images comprising:
a computer having an Internet connection;
at least one interface connected to said computer for uploading electronic images from a storage medium to said computer; and
a display screen connected to said computer;
wherein a user stores an electronic image on a storage medium with an electronic storage device and transfers said electronic image from said storage medium to said computer via said interface; and
wherein said user views said electronic image on said display screen and electronically sends a message to a desired recipient over the Internet, said message including information about a server website that includes said electronic image.

19. The interactive electronic image station of claim 18 wherein said message includes a hyperlink to said server website that includes said electronic image.

20. A method for viewing and sending electronic images at an interactive electronic image station comprising the steps of:
recording an electronic image on a storage medium;
inserting said storage medium into an interface connected to a computer, said computer being housed in an electronic image station in the form of a kiosk;
viewing said electronic image on a display screen connected to said computer;
selecting to send said electronic image to a desired recipient over the Internet;
inputting into said computer an e-mail address for said desired recipient; and
initiating electronic transmission of said electronic image to said desired recipient over the Internet.

21. The method of claim 20 further comprising the steps of:
viewing pre-selected electronic images stored in a memory of said computer;
selecting to send at least one of said pre-selected electronic images to said desired recipient over the Internet; and
initiating electronic transmission of said at least one of said pre-selected electronic images to said desired recipient.

22. The method of claim 20 further comprising the steps of inputting into said computer a personal text message for said desired recipient and initiating electronic transmission of said personal text message with said electronic image.

23. The method of claim 20 further comprising the steps of recording an audible message on a audible storage medium connected to said computer and initiating electronic transmission of said audible message with said electronic image.

24. The method of claim 20 further comprising the steps of recording a video clip on a video storage medium connected to said computer and initiating electronic transmission of said video clip with said electronic image.

25. A method for viewing and sending electronic images at an interactive electronic image station comprising the steps of:
recording an electronic image on a storage medium;
inserting said storage medium into an interface connected to a computer, said computer being housed in an electronic image station in the form of a kiosk;
viewing said electronic image on a display screen connected to said computer; and
initiating electronic transmission of a message to a desired recipient over the Internet;
wherein said message includes information about a server website that includes said electronic image.

26. The method of claim 25 wherein said message includes a hyperlink to said server website that includes said electronic image.

27. A method for enabling viewing and sending of electronic images at an interactive electronic image station comprising the steps of:
housing said interactive electronic image station within a kiosk environment;
uploading an electronic image from a storage medium to a computer within said interactive electronic image station via an interface;
displaying said electronic image on a display screen connected to said computer; and
electronically transmitting said electronic image via the Internet to an e-mail address input by a user.

28. The method of claim 27 further comprising the steps of:
storing in a memory within said computer a plurality of pre-selected electronic images;
displaying at least one of said pre-selected images on said display screen; and
electronically transmitting said at least one of said pre-selected electronic images via the Internet to said e-mail address input by said user.

29. The method of claim 27 further comprising the step of notifying said user whether transmission of said of said electronic image to said desired recipient is successful.

30. A method for enabling viewing and sending of electronic images at an interactive electronic image station comprising the steps of:
housing said interactive electronic image station within a kiosk environment;
uploading an electronic image from a storage medium to a computer within said interactive electronic image station via an interface;
displaying said electronic image on a display screen connected to said computer; and
electronically transmitting a message via the Internet to an e-mail address input by a user;
wherein said message includes information about a server website that includes said electronic image.

31. The method of claim 30 wherein said message includes a hyperlink to said server website that includes said electronic image.
